(19) United States
(12) Patent Application Publication
(10) Pub. No.: US 2010/0012616 A1
(43) Pub. Date: Jan. 21, 2010

(54) ASSEMBLY WITH BOTTLE STOPPER AND METHODS OF USING THE SAME

(75) Inventor: Kevin Guy, Moorpark, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: PICNIC TIME, INC., Moorpark, CA (US)

(21) Appl. No.: 12/177,059

(22) Filed: Jul. 21, 2008

(51) Int. Cl. B65D 39/00; B23Q 3/00; B23P 19/04

(52) U.S. Cl. 215/355; 269/289 R; 29/700

(57) ABSTRACT

An assembly is provided. The assembly preferably includes at least one board, at least one opening on the board, and at least one bottle stopper removeably disposed in the opening.

### FIELD OF THE INVENTION

The present invention relates to assemblies, and, more particularly, to assemblies having bottle stoppers or implements, and methods of using the same.

### BACKGROUND OF THE INVENTION

Cutting boards and/or boards generally have one or more surfaces for cutting and can be used in a variety of locations and situations. For example, if cheese and wine are going to be served at a picnic, a cutting board and other implements would be helpful to have on hand; however, carrying all these items to a picnic would be burdensome. Accordingly, a cutting board that can serve multiple purposes and hold multiple items would be extremely helpful.

### SUMMARY OF THE PREFERRED EMBODIMENTS

According to one aspect of the present invention, there is provided an assembly comprising at least one board; at least one opening on the board; and at least one bottle stopper removeably disposed in the opening. Preferably, opening is on a lateral side of the board. In a preferred embodiment, at least one board is a cutting board and/or includes a surface for cutting. Preferably, the assembly has an open and/or expanded position and a closed and/or folded position. In a preferred embodiment, the assembly includes a first board and a second board, and the first board is moveable past the second board. Preferably, the bottle stopper is removable/capable of being removed in the closed position or folded position and/or the open position or the expanded position. Preferably, the bottle stopper is removeably disposed in the opening in the open and/or the expanded position and/or the closed or folded position.

According to another aspect of the present invention, there is provided a method of inserting a bottle stopper into the mouth of a bottle. The method includes the steps of providing an assembly comprising at least one board, at least one opening on the board; and at least one bottle stopper removeably disposed in the opening; wherein the bottle stopper at least partially protrudes from the opening. In a preferred embodiment, at least one board of the assembly is a cutting board and/or includes a surface for cutting. The method further comprises the steps of pulling on at least a portion of the bottle stopper that protrudes from the board so that the bottle stopper is no longer disposed/held in the opening and inserting/placing the bottle stopper into a mouth of a bottle. Preferably, the bottle is a wine bottle. In a preferred embodiment, the assembly is capable of opening or expanding and closing or folding. The bottle stopper can be pulled from the opening when the assembly is in the open or expanded position and/or when the assembly is in the closed or folded position. Additionally, the bottle stopper can be removed from the mouth of the bottle and inserted back into the opening.

According to another aspect of the present invention, there is provided an assembly comprising at least one board; at least one opening on the board; and at least one implement removeably disposed in the opening.

According to another aspect of the present invention, there is provided an assembly for holding an implement. Preferably, the assembly comprises a body that is not a bottle, the body having a cutting surface and at least one other surface and an opening on the other surface. An implement is snugly but releasingly disposed with the opening. In a preferred embodiment, the implement is selected from the group consisting of a bottle stopper, a corkscrew, and a utensil. Preferably the body comprises at least one cutting board.

Other objects, features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description can be made without departing from the spirit thereof, and the description should be understood to include all such variations.

### BRIEF DESCRIPTION OF THE DRAWINGS

The invention can be more readily understood by referring to the accompanying drawings in which:

FIG. 1 is a top perspective view of an assembly in accordance with a preferred embodiment of the present invention;

FIG. 2 is a top plan view of the assembly of FIG. 1 showing an outside surface of the assembly;

FIG. 3 is a top plan view of the assembly of FIG. 1 showing an inside surface of the assembly;

FIG. 4 is a perspective view of the assembly of FIG. 1 with the assembly in an open position or expanded position;

FIG. 5 is an exploded view of the assembly of FIG. 1;

FIG. 6 is a bottom perspective view of the assembly of FIG. 1; and

FIG. 7 is a bottom perspective view of an assembly having an opening on top side of the board in accordance with another preferred embodiment of the present invention.

Like numerals refer to like parts throughout the several views of the drawings.

### DETAILED DESCRIPTION OF THE PREFERRED EMBODIMENTS

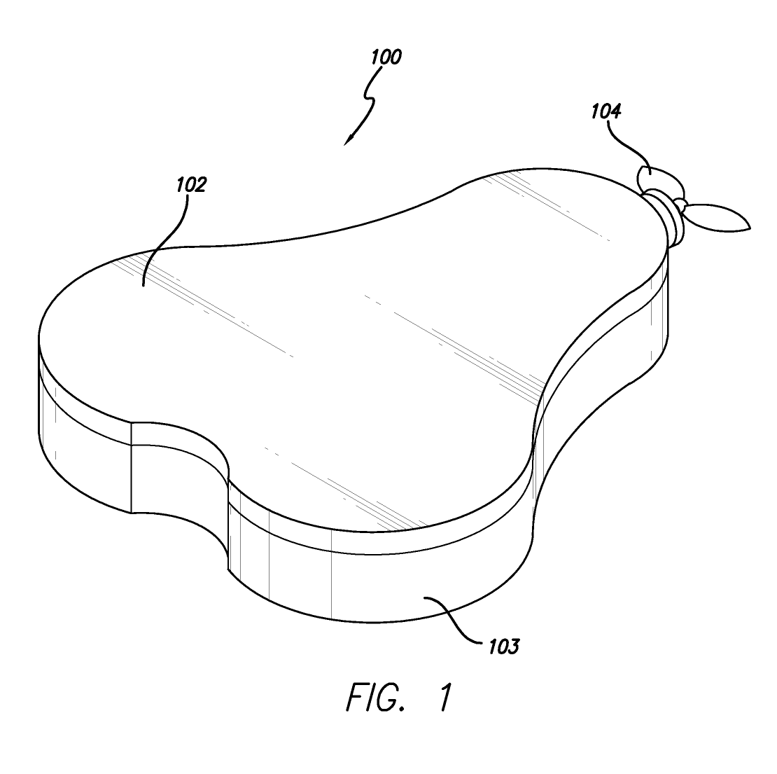

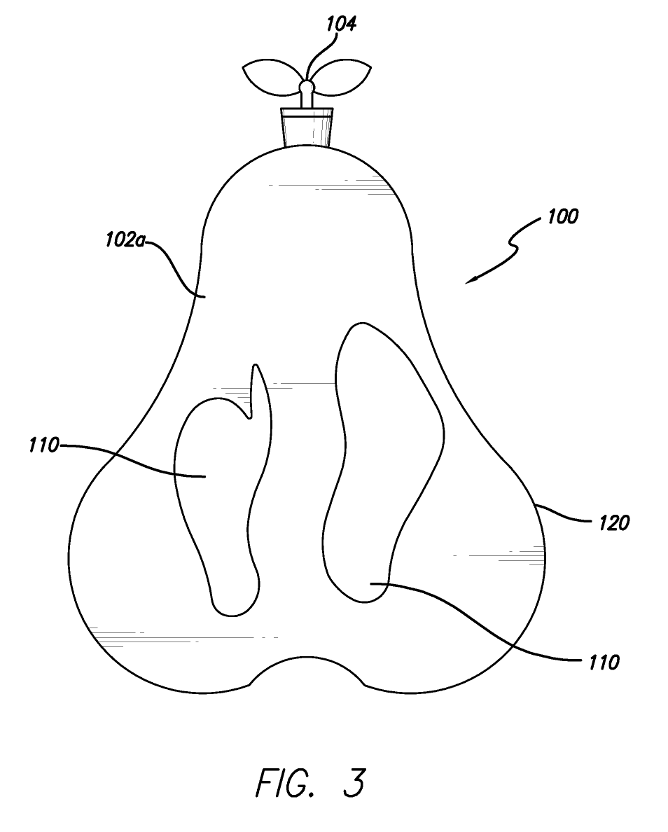

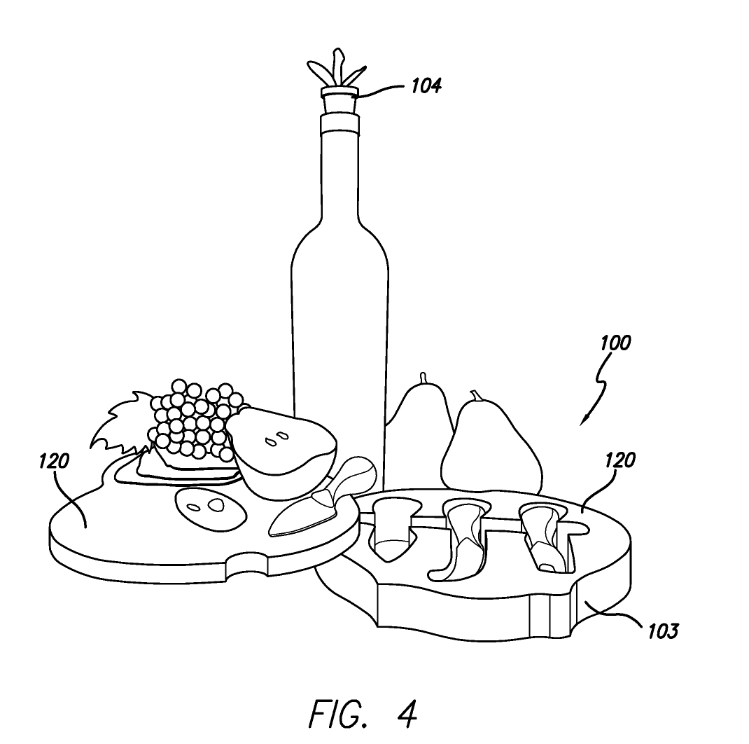

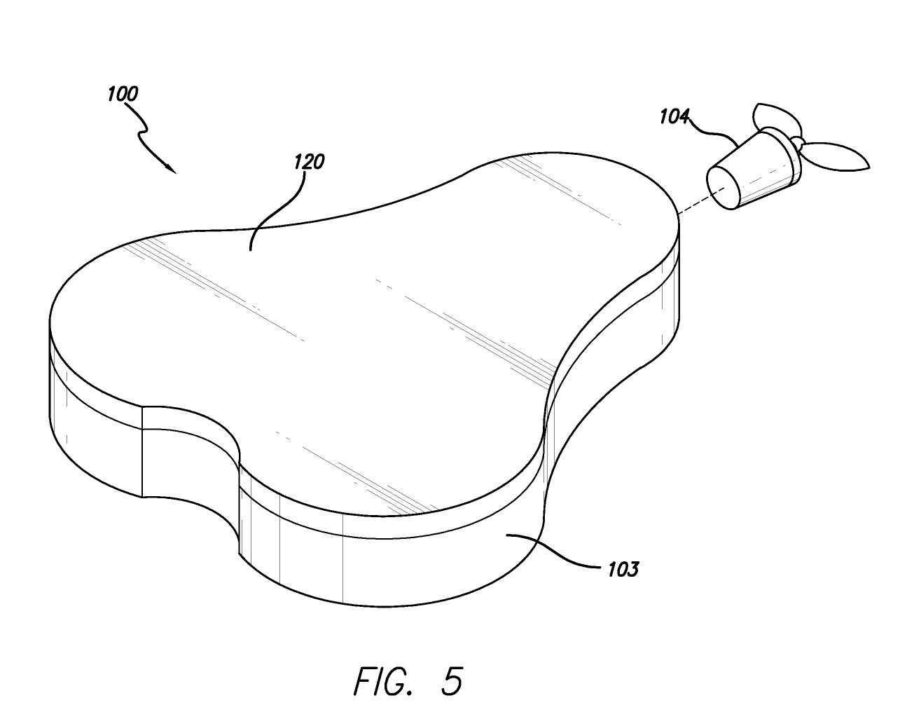

Referring to FIGS. 1-7, a preferred embodiment of the assembly of the present invention is described.

It will be understood that terms such as “front,” “back,” “top,” “bottom,” and “side” used herein are merely for the ease of description, and refer to the orientation of components shown in the figures. It should be understood that any orientation of the assembly, and the components thereof disclosed herein, is within the scope of the present invention.

Referring to FIGS. 1-7, the assembly 100 preferably includes at least one board 102 (“referred to individually and collectively as “102”, at least one opening 108 on/located on/formed on the board 102, and at least one bottle stopper 104 or implement removeably disposed in the opening 108. As used herein, “board” can refer to “cutting board” or any other board, i.e., a board with at least a partial surface for cutting food or without a surface for cutting food. For example, “board” can refer to a flat slab of wood or substantially flat slab of wood or other material. Preferably, at least a portion of the board is flat.

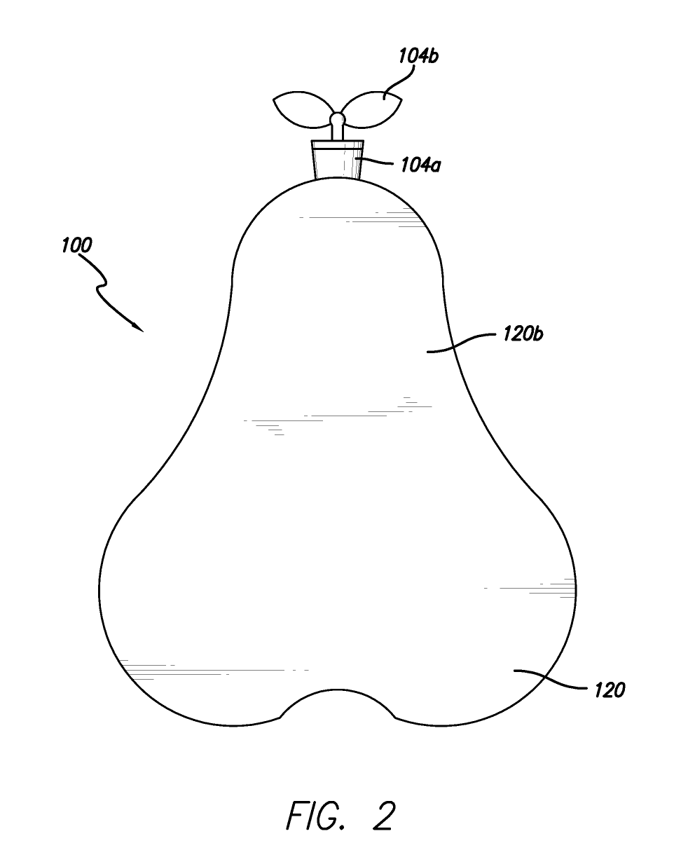

In a preferred embodiment, bottle stopper 104 is removeably disposed in opening. Referring to FIG. 2, the bottle stopper 104 can have a bottle stopper portion 104a and handle portion 104b. The bottle stopper portion 104a preferably fits into the bottle, such as a wine bottle, in place of a cork, for example. In other embodiments, in connection with, or in lieu of the bottle stopper 104, any implement can be removeably disposed in the opening 108. As such, as used herein, “bottle stopper” can refer to any other implement, such as, a corkscrew, utensil, or the like. For example, instead of a bottle stopper or in connection with a bottle stopper, a corkscrew, utensil, or the like, can be removeably disposed in opening 108, with each of such items having a body portion snugly disposed in the opening and a handle portion extending out of the opening for ready grasping. In other embodiments, the bottle stopper or implement can be omitted from the assembly 100.

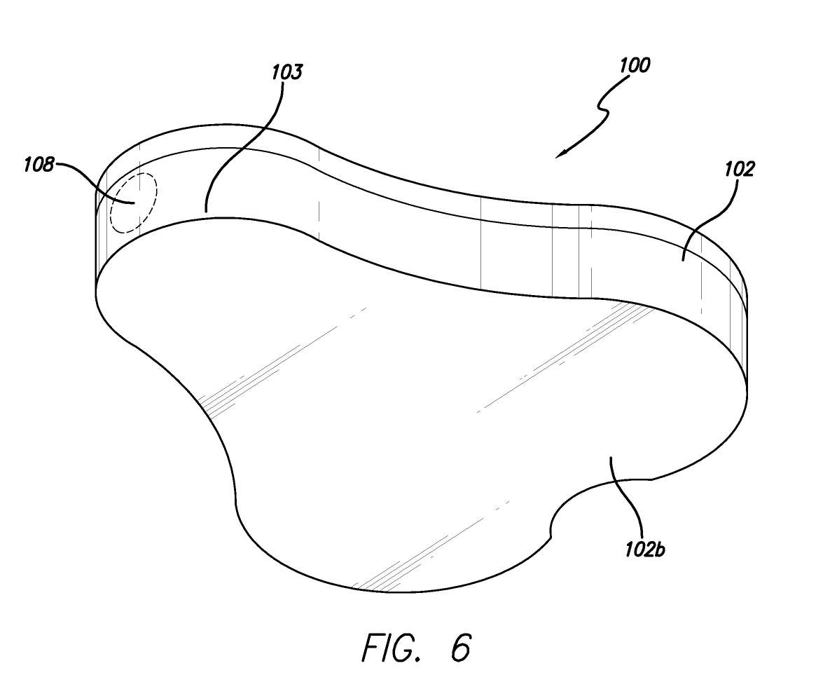

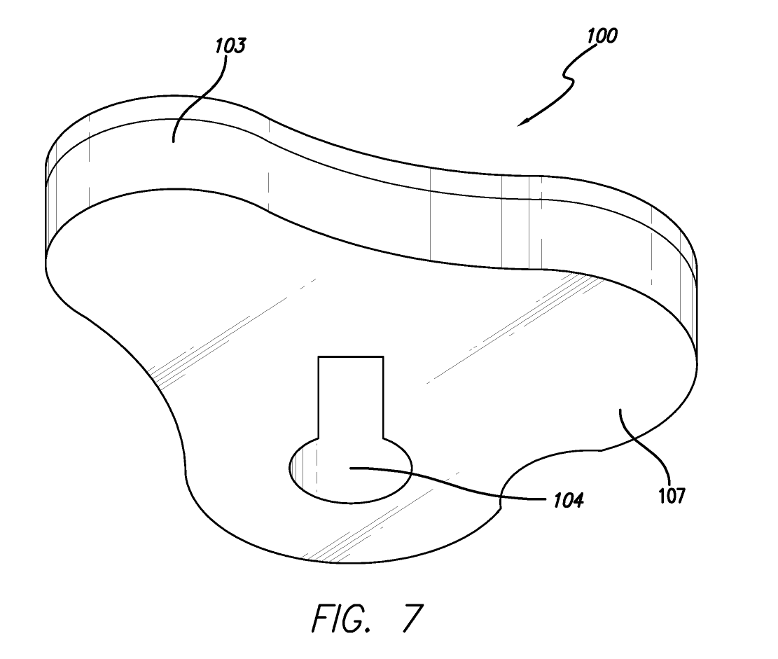

As best shown in FIGS. 2-3 and FIG. 6., the opening 108 is preferably located and/or formed on lateral side 103 of the assembly 100. In a preferred embodiment, and as best shown in FIG. 6, the opening 108 is located on the lateral side 103 of thicker board 102. In other embodiments, the opening 108 can be located on and/or formed on any other part of the assembly 100. For example, as best shown in FIG. 7, the opening 108 having bottle stopper 104 removably disposed therein can be located and/or formed on top side of board 102, preferably top surface 102b of the thicker board 102. In yet other embodiments, more than one opening 108 can be used. In yet other embodiments, instead of an opening, another type of cavity and/or another suitable mechanism for receiving a bottle stopper or implement can be used.

In a preferred embodiment, the opening 108 is deep enough to receive the bottle stopper 104 or other implement, but shallow enough so that at least a portion of the bottle stopper 104, such as the handle portion 104b, or implement protrudes from the opening 108 to the outside. The depth of the opening 108 can be manufactured depending on the size of the bottle stopper 104 or implement received/removably held therein. Preferably, the shape and size of the opening conforms to the shape/size of the portion of the bottle stopper or implement housed therein to provide a snug fit.

In a preferred embodiment, the opening 108 is from about 0.5 inches to about 5 inches deep; preferably, from about 0.7 inches to about 3.0 inches deep; most preferably from about 0.9 to about 2.0 inches deep. In a highly preferred embodiment, the opening 108 is about 1 inch deep. In a preferred embodiment, the opening 108 is of appropriate depth to snugly hold a wine bottle stopper and/or the bottle stopper portion of the wine bottle stopper. In other embodiments, the opening 108 may be of any other depth to hold the bottle stopper 104 or other implement. For example, the depth of the opening 108 can be based upon the length of the bottle stopper or implement received therein.

Additionally, the opening 108 is of an appropriate diameter to receive the bottle stopper 104 or other implement and hold it in the opening 108. In a preferred embodiment, the opening is from about 0.5 inches to about 2 inches in diameter; preferably, from about 0.7 inches to about 1.5 inches in diameter; and most preferably, from about 0.9 inches to about 1.3 inches in diameter. The diameter of the opening 108 can be the same or uniform throughout the opening 108 and can be manufactured based upon the size of the bottle stopper 104 or implement. In other embodiments, the opening 108 may be of any other diameter to hold the bottle stopper 104 or other implement.

In a preferred embodiment, the assembly 100 is manufactured so that it can be opened and/or extended or folded and/or closed. In this regard, the assembly 100 can be manufactured to include more than one board 102. For ease of description, each board 102 can be referred to herein as “102” as well as identified as “first” or “second.” For example, the assembly 100 can be manufactured to include a first board 102 and a second board 102. The first board 102 and the second board 102 can be attached to each other such that one board is slideable or movable past the other. Additionally, one board can be manufactured to be thicker than the other board. It is to be understood that each board can have a surface for cutting; and, as such, can be a cutting board. In other embodiments, the board can have a surface made of any other type of material that may or may not be suitable for cutting. Preferably, the thicker board has a surface for cutting. Further, it is to be understood that the assembly 100 can include any number of boards without departing from the scope of the present invention.

In a preferred embodiment, each board 102 of the assembly 100 includes an inside surface 102a and an outside surface 102b. The inside surface 102a preferably includes at least one aperture 110 for receiving implements, utensils, food, or the like. The outside surface 102b preferably includes a surface suitable for cutting food. In other embodiments, the outside surface 102b can include at least one aperture 110 for receiving implements, utensils, food, or the like. In yet other embodiments, the aperture 110 can be omitted from the inside surface 102a and/or the outside surface 102b.

In a preferred embodiment, the assembly 100 is pear-shaped. In other embodiments, the assembly 100 can be configured in any other shape. Additionally, the assembly can be of one shape when opened or extended and of a different shape when closed or folded.

In a preferred embodiment, the assembly 100 is comprised of wood or mixtures of wood and any other material. In other embodiments, the assembly is comprised of any other suitable material, or a mixture of any other suitable material. For example, the outside surface 102b can be comprised of a material suitable for cutting, such as wood or the like, and the inside surface 102a can be comprised of plastic or the like.

### METHODS OF THE PRESENT INVENTION

Preferably, the methods of the present invention include providing an assembly as disclosed herein. Preferably, the first assembly is capable of being opened or expanded and closed or folded and includes two boards. In a preferred embodiment, the method includes the step of moving one board away from the other board, thereby placing the assembly in an open or expanded position. The method also includes the step of moving one board towards the other board, thereby placing the assembly in a closed or folded position.

In a preferred embodiment, the method includes the step of pulling on at least a portion of the bottle stopper or implement that protrudes from the opening, such as the handle portion. In other embodiments, the method includes the step of twisting and/or pushing, or the like, on at least a portion of the bottle stopper or implement that protrudes from the opening. It is to be understood that the bottle stopper can be removed in any fashion from the opening without departing from the scope of the present invention.

In a preferred embodiment, the method includes the step of inserting the bottle stopper into the mouth of the bottle, preferably a bottle containing wine or other beverage. Preferably, the step of inserting the bottle stopper includes the step of pushing the bottle stopper into the mouth of the bottle. Preferably, at least a portion of the stopper portion of the bottle stopper is pushed into the mouth of the bottle. In other embodiments, the step of inserting the bottle stopper into the mouth of the bottle includes the step of screwing in the bottle stopper, or at least a portion of the stopper portion, or the like.

The following examples are presented to enable those skilled in the art to understand and practice the invention and to identify the presently preferred embodiments thereof. These examples are provided for illustrative purposes and not to indicate the scope of the invention which is defined only by the appended claims.

### EXAMPLE 1

An assembly of the present invention is provided. Preferably, the assembly includes boards coupled to each other such that the boards are moveable/slideable past each other. Each board includes an outer surface and an inner surface. The inner surfaces of each of board can include apertures for receiving utensils and/or picnic items.

### EXAMPLE 2

The assembly of Example 1 is opened or expanded, and implements/utensils and/or food, or the like, are placed in the appropriate apertures. The assembly is subsequently closed or folded. A bottle stopper, or a portion thereof, is thereafter removeably placed into an opening on the assembly.

### EXAMPLE 3

The assembly of Example 1 is provided. The assembly is opened or expanded, and implements/utensils and/or food or the like are placed in the appropriate apertures. A bottle stopper, or a portion thereof, is inserted into an opening on the assembly. The assembly is placed in the closed position or folded position.

### EXAMPLE 4

The assembly of Example 1 or Example 2, along with a bottle of wine or other beverage of choice, is taken to the beach or any other location. The bottle of wine is opened using a corkscrew or the like. Accordingly, the cork is removed. One board is moved away from the other, exposing the contents held therein, thereby placing the assembly in the open position or expanded position. In this position, the bottle stopper is pulled from the opening.

### EXAMPLE 5

The assembly of Example 1 or Example 2, along with a bottle of wine or other beverage of choice, is taken to the beach or any other location. The bottle of wine is opened using a corkscrew or the like. Accordingly, the cork is removed. One board is slideable past the other board, exposing the contents held therein, thereby placing the assembly in the open position. Utensils can be removed from the apertures. One board is moved towards the other, thereby placing the assembly in the closed position or folded position. In this position, the bottle stopper is removed from the opening.

### EXAMPLE 6

The bottle stopper of Example 4 or 5 is inserted into the mouth of the bottle of wine. The bottle stopper is subsequently removed from the mouth of the bottle and placed back in the opening in the assembly.

What is claimed is:

1. An assembly comprising:
(a) at least one board;
(b) at least one opening on the board; and
(c) at least one bottle stopper removeably disposed in the opening.

2. The assembly of claim 1, wherein the opening is on a lateral side of the board.

3. The assembly of claim 1, wherein the assembly has an open or expanded position and a closed or folded position.

4. The assembly of claim 3, wherein the board assembly comprises:
(a) a first board and
(b) a second board;
wherein the first board is moveable past the second board.

5. The assembly of claim 3, wherein the bottle stopper is removable from the opening in the closed position or folded position.

6. The assembly of claim 3, wherein the bottle stopper is removable from the opening in the open position or expanded position.

7. The assembly of claim 3, wherein the bottle stopper is removeably disposed in the opening in the open or expanded position.

8. The assembly of claim 3, wherein the bottle stopper is removeably disposed in the opening in the closed or folded position.

9. A method of inserting a bottle stopper into a bottle, comprising:
(a) providing an assembly comprising:
(1) at least one board;
(2) at least one opening on the board; and
(3) at least one bottle stopper removeably disposed in the opening;
wherein at least a portion of the bottle stopper protrudes from the opening;
(b) pulling on at least a portion of the bottle stopper that protrudes from the opening so that the bottle stopper is no longer disposed in the opening; and
(c) inserting the bottle stopper into a mouth of a bottle.

10. The method of claim 9, wherein the bottle is a wine bottle.

11. The method of claim 9, wherein the assembly is capable of opening or expanding and closing or folding.

12. The method of claim 11, wherein the bottle stopper is pulled from the opening when the assembly is in the open or expanded position.

13. The method of claim 11, wherein the bottle stopper is pulled from the opening when the assembly is in the closed or folded position.

14. The method of claim 11, further comprising the step of removing the bottle stopper from the mouth of the bottle.

15. The method of claim 14, further comprising the step of inserting the bottle stopper into the opening.

16. An assembly comprising:
(a) at least one board;
(b) at least one opening on the board; and
(c) at least one implement removeably disposed in the opening.

17. The assembly of claim 16, wherein the assembly has an open or expanded position and a closed or folded position.

18. The method of claim 9, wherein the opening is on a lateral side of the board.

19. The assembly of claim 1, wherein the board is a cutting board.

20. The method of claim 9, wherein the board is a cutting board.

21. An assembly for holding a implement, the assembly comprising:
(a) a body that is not a bottle, the body comprising:
(i) a cutting surface and at least one other surface;
(ii) an opening on the other surface; and
(b) an implement snugly but releasingly disposed within the opening.

22. The assembly of claim 21, wherein the implement is selected from the group consisting of a bottle stopper, a corkscrew, and a utensil.

23. The assembly of claim 21, wherein the body comprises at least one cutting board.
